(19) United States
(12) Patent Application Publication
(10) Pub. No.: US 2017/0097503 A1
(43) Pub. Date: Apr. 6, 2017

(54) MULTI-BEAM SCANNER AND CONFOCAL OPTICAL SYSTEM INCLUDING THE SAME

(71) Applicant: Samsung Electronics Co., Ltd., Suwon-si (KR)

(72) Inventor: Kohei Hashimoto, Suwon-si (KR)

(21) Appl. No.: 15/242,147

(22) Filed: Aug. 19, 2016

(30) Foreign Application Priority Data
Oct. 6, 2015 (KR) 10-2015-0140163

(51) Int. Cl. G02B 26/12; G02B 21/00

(52) U.S. Cl. CPC G02B 26/123; G02B 21/0048; G02B 26/124; G02B 26/125; G02B 26/127

(57) ABSTRACT

A multi-beam scanner may include a scan lens and a reflecting mirror. The scan lens may have eccentric incidence points offset from a center point of the scan lens to which at least two light beams may be irradiated. The scan lens may be configured to concentrate the light beams. The concentrated light beams may be incidence to the reflecting mirror. Thus, an object may be scanned by the light beams using only one scan lens so that the multi-beam scanner may have a less complex structure.

### CROSS-RELATED APPLICATION

This application claims priority under 35 USC §119 to Korean Patent Application No. 10-2015-0140163, filed on Oct. 6, 2015 in the Korean Intellectual Property Office (KIPO), the contents of which are hereby incorporated herein by reference in their entirety.

### FIELD

Example embodiments relate to a multi-beam scanner and a confocal optical system including the same. More particularly, example embodiments relate to a multi-beam scanner configured to scan an object using a plurality of light beams, and a confocal optical system including the multi-beam scanner.

### BACKGROUND

Generally, a tester or a microscope using a confocal optical system may scan an object using a light to obtain an image of the object. In order to rapidly scan the object, a multi-beam scanner may scan the object using a plurality of light beams.

According to related arts, the object may be scanned by multiple light beams using a single polygon mirror and a plurality of scan lenses. That is, because each light beam may pass through a center point of each of the scan lenses, the scan lenses corresponding to numbers of the light beams may be required. Thus, the multi-beam scanner may have a complicated structure due to the scan lenses. Further, in order to prevent light interference, the light beams may have optical paths positioned on different horizontal planes. Thus, the polygon mirror for reflecting the light beams may have a thick thickness.

### SUMMARY

Example embodiments provide a multi-beam scanner having a lens complex structure.

Example embodiments also provide a confocal optical system including the above-mentioned multi-beam scanner.

According to example embodiments, there may be provided a multi-beam scanner. The multi-beam scanner may include a scan lens and a reflecting mirror. The scan lens may have eccentric incidence points offset from a center point of the scan lens to which at least two light beams may be irradiated. The scan lens may be configured to focus on direct light beams towards a reflecting mirror.

In example embodiments, the light beams may be directed to a single point of the reflecting mirror.

In example embodiments, the eccentric incidence points may be positioned on substantially the same horizontal plane.

In example embodiments, the reflecting mirror may be configured to reflect the light beams to the scan lens.

In example embodiments, the light beams reflected from the reflecting mirror may pass through eccentric exit points of the scan lens different from the eccentric incidence points to be converted into planar light beams.

In example embodiments, the eccentric exit points may be positioned on substantially the same horizontal plane.

In example embodiments, the reflecting mirror may include a polygon mirror having a plurality of reflecting faces and configured to be rotated with respect to a vertical axis.

In example embodiments, the reflecting mirror may include a galvano mirror having a single reflecting face and being alternately rotated with respect to a vertical axis in a positive direction and a reverse direction.

In example embodiments, the multi-beam scanner may further include beam splitters configured to split the light beams, and inclined mirrors configured to reflect the split light beams to the eccentric incidence points of the scan lens.

In example embodiments, the multi-beam scanner may further include convex lenses arranged between the beam splitters and the inclined mirrors to concentrate the split light beams on the inclined mirrors.

According to example embodiments, there may be provided a confocal optical system. The confocal optical system may include a scan lens, a reflecting mirror, an objective lens and a detecting unit. The scan lens may have eccentric incidence points offset from a center point of the scan lens to which at least two light beams may be directed. The scan lens may be configured to concentrate the light beams. The reflecting mirror may be configured to reflect the concentrated light beams to the scan lens. The objective lens may be arranged between the scan lens and an object. The detecting unit may be configured to detect light beams reflected from the object.

In example embodiments, the confocal optical system may further include a second objective lens arranged between the objective lens and the scan lens to concentrate the light beams on the objective lens.

In example embodiments, the reflecting mirror may include a polygon mirror having a plurality of reflecting faces and being rotated with respect to a vertical axis.

In example embodiments, the confocal optical system may further include beam splitters configured to split the light beams, and inclined mirrors configured to reflect the split light beams to the eccentric incidence points of the scan lens.

In example embodiments, the confocal optical system may further include convex lenses arranged between the beam splitters and the inclined mirrors to focus or concentrate the split light beams on the inclined mirrors.

According to example embodiments, the incidence points of the light beams may be offset from the center point of the scan lens so that the object may be scanned by the light beams using only one scan lens. Further, the light beams passing through the scan lens may be directed to the single point of the reflecting mirror so that the reflecting mirror may have a thin thickness. As a result, the multi-beam scanner and the confocal optical system may have a simple structure.

### BRIEF DESCRIPTION OF THE DRAWINGS

Example embodiments will be more clearly understood from the following detailed description taken in conjunction with the accompanying drawings. FIGS. 1 to 14 represent non-limiting, example embodiments as described herein.

FIG. 1 is a perspective view illustrating a multi-beam scanner in accordance with example embodiments;

FIG. 2 is a plan view illustrating the multi-beam scanner in FIG. 1;

FIG. 3 is a front view illustrating the multi-beam scanner in FIG. 1;

FIG. 4 is a perspective view illustrating a multi-beam scanner in accordance with example embodiments;

FIG. 5 is a plan view illustrating the multi-beam scanner in FIG. 4;

FIG. 6 is a front view illustrating the multi-beam scanner in FIG. 4;

FIG. 7 is a perspective view illustrating a multi-beam scanner in accordance with example embodiments;

FIG. 8 is a plan view illustrating the multi-beam scanner in FIG. 7;

FIG. 9 is a front view illustrating the multi-beam scanner in FIG. 7;

FIG. 10 is a perspective view illustrating a multi-beam scanner in accordance with example embodiments;

FIG. 11 is a perspective view illustrating a multi-beam scanner in accordance with example embodiments;

FIG. 12 is a perspective view illustrating a confocal optical system including the multi-beam scanner in FIG. 1;

FIG. 13 is a plan view illustrating the confocal optical system in FIG. 12; and

FIG. 14 is a front view illustrating the confocal optical system in FIG. 12.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

Multi-Beam Scanner

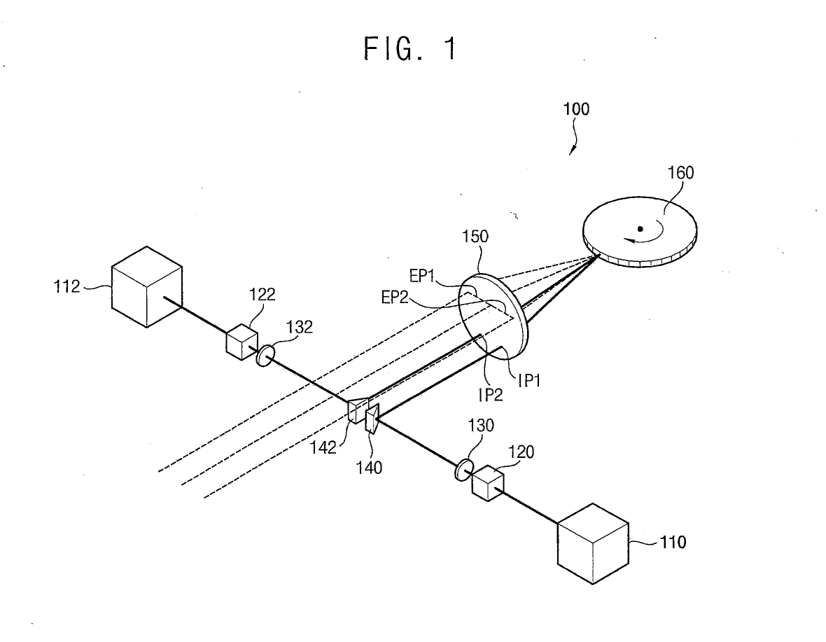

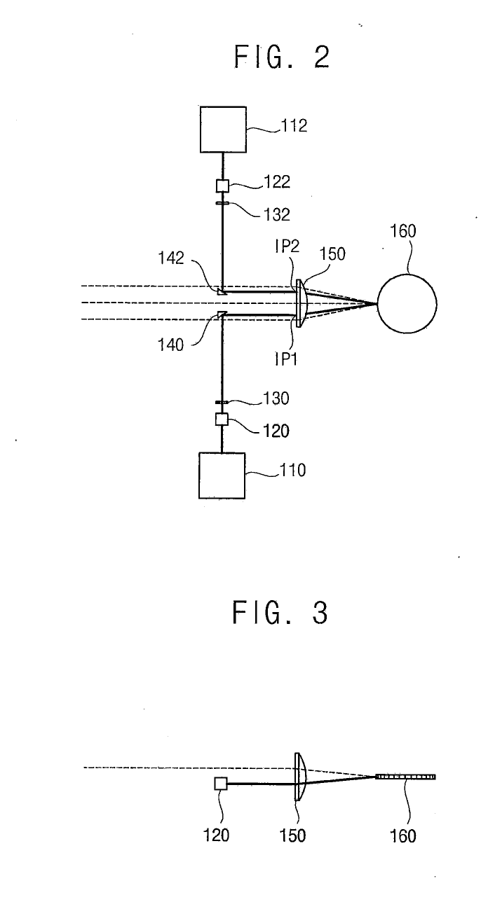

FIG. 1 is a perspective view illustrating a multi-beam scanner in accordance with example embodiments, FIG. 2 is a plan view illustrating the multi-beam scanner in FIG. 1, and FIG. 3 is a front view illustrating the multi-beam scanner in FIG. 1.

Referring to FIGS. 1 to 3, a multi-beam scanner 100 of this example embodiment may be configured to scan an object using a plurality of light beams. The light beams may include a laser beam. The multi-beam scanner 100 may include a first light source 110, a second light source 112, a first beam splitter 120, a second beam splitter 122, a first convex lens 130, a second convex lens 132, a first inclined mirror 140, a second inclined mirror 142, a scan lens 150 and a polygon mirror 160.

The scan lens 150 may be arranged between the polygon mirror 160 and the object. The scan lens 150 may be arranged facing the object. Thus, the scan lens 150 may have a horizontal center axis.

The first light source 110 may be arranged at a right portion between the scan lens 150 and the object. The first light source 110 may be arranged under the horizontal center axis of the scan lens 150. The first light source 110 may be configured to emit a first light beam having a linear shape along a first optical path substantially perpendicular to the horizontal center axis.

The first beam splitter 120 may be arranged on the first optical path in front of the first light source 110. The first beam splitter 120 may split the first light beam emitted from the first light source 110.

The first convex lens 130 may be arranged on the first optical path in front of the first beam splitter 120. The first convex lens 130 may concentrate the first light beam split by the first splitter 120. That is, the first convex lens 130 may converge the first light beam split by the first splitter 120.

The first inclined mirror 140 may be arranged on the first optical path. The first inclined mirror 140 may reflect the first light beam concentrated by the first convex lens 130 at an angle of about 90° toward the scan lens 150. The first light beam reflected from the first inclined mirror 140 may be substantially parallel to the horizontal center axis of the scan lens 150. The first light beam reflected from the first inclined mirror 140 may be directed to a first eccentric incidence point IP1 of the scan lens 150 offset from a center point of the scan lens 150. The first eccentric incidence point IP1 may be positioned at a right lower portion of the scan lens 150.

In example embodiments, the first light beam emitted from the first light source 110 may not be directly irradiated to the polygon mirror 160. The first light beam may be directed to the polygon mirror 160 through the scan lens 150. Further, the first light beam may be directed to the first eccentric incidence point IP1 offset from the center point of the scan lens 150, not the center point of the scan lens 150.

In example embodiments, the first light source 110 may emit the first light beam along the first optical path substantially perpendicular to the horizontal center axis of the scan lens 150. Alternatively, the first optical path may not be perpendicular to the horizontal center axis of the scan lens 150. For example, the first optical path may be inclined to the horizontal center axis at an acute angle or an obtuse angle. In this case, the first light beam reflected from the first inclined mirror 140 may be directed to the first eccentric incidence point IP1 parallel to the horizontal center axis by adjusting an angle of the first inclined mirror 140.

The second light source 112 may be arranged at a left portion between the scan lens 150 and the object. The second light source 112 may be arranged under the horizontal center axis of the scan lens 150. The second light source 112 may be positioned on a horizontal plane substantially coplanar with the first light source 110. Further, a distance between the scan lens 150 and the second light source 112 may be substantially the same as a distance between the scan lens 150 and the first light source 110. The second light source 112 may be configured to emit a second light beam having a linear shape along a second optical path substantially perpendicular to the horizontal center axis. Because the first light source 110 may be coplanar with the second light source 112, the second optical path may also be coplanar with the first optical path. The first optical path and the second optical path may be positioned on a single straight line.

The second beam splitter 122 may be arranged on the second optical path in front of the second light source 112. The second beam splitter 122 may split the second light beam emitted from the second light source 112.

The second convex lens 132 may be arranged on the second optical path in front of the second beam splitter 122. The second convex lens 132 may concentrate the second light beam split by the second splitter 122.

The second inclined mirror 142 may be arranged on the second optical path. The second inclined mirror 142 may reflect the second light beam concentrated by the second convex lens 132 at an angle of about 90° toward the scan lens 150. The second light beam reflected from the second inclined mirror 142 may be substantially parallel to the horizontal center axis of the scan lens 150. The second light beam reflected from the second inclined mirror 142 may be irradiated to a second eccentric incidence point IP2 of the scan lens 150 offset from the center point of the scan lens 150. The second eccentric incidence point IP2 may be positioned at a left lower portion of the scan lens 150. Because the first optical path and the second optical path may be coplanar with each other, the first eccentric incidence point IP1 and the second eccentric incidence point IP2 may also be coplanar with each other.

Further, the first beam splitter 120, the first convex lens 130, the first inclined mirror 140, the second beam splitter 122, the second convex lens 132 and the second inclined mirror 142 may be positioned on the horizontal plane.

In example embodiments, the second light beam emitted from the second light source 112 may not be directly irradiated to the polygon mirror 160. The second light beam may be irradiated to the polygon mirror 160 through the scan lens 150. Further, the second light beam may be directed to the second eccentric incidence point IP2 offset from the center point of the scan lens 150, not the center point of the scan lens 150.

In example embodiments, the second light source 112 may emit the second light beam along the second optical path substantially perpendicular to the horizontal center axis of the scan lens 150. Alternatively, the second optical path may not be perpendicular to the horizontal center axis of the scan lens 150. For example, the second optical path may be inclined to the horizontal center axis at an acute angle or an obtuse angle. In this case, the second light beam reflected from the second inclined mirror 142 may be irradiated to the second eccentric incidence point IP2 parallel to the horizontal center axis by adjusting an angle of the second inclined mirror 142.

The scan lens 150 may include a single lens. Particularly, the multi-beam scanner 100 may include only one scan lens 150 regardless of numbers of the light sources. The scan lens 150 may include a convex lens. Thus, the first light beam passing through the first eccentric incidence point IP1 of the scan lens 150 and the second light passing through the second eccentric incidence point IP2 of the scan lens 150 may be concentrated on a single point of the polygon mirror 160. In other words, the first light beam and the second light beam are focused towards the same location on the mirror 160.

The polygon mirror 160 may include a reflecting mirror configured to reflect the first light beam and the second light beam toward the scan lens 150. The polygon mirror 160 may be rotated with respect to a vertical axis in a uni-direction. The polygon mirror 160 may have a plurality of reflecting faces configured to reflect the first light beam and the second light beam. The first light beam passing through the first eccentric incidence point IP1 of the scan lens 150 and the second light beam passing through the second eccentric incidence point IP2 of the scan lens 150 may be concentrated on any one of the reflecting faces of the polygon mirror 160. Particularly, because the first eccentric incidence point IP1 and the second eccentric incidence point IP2 may be positioned on the substantially same horizontal plane, the first light beam and the second light beam may be overlapped with each other on one reflecting face of the polygon mirror 160. The first light beam and the second light beam may be irradiated to one point of the polygon mirror 160. Thus, the first light beam and the second light beam may be concentrated on one point of the reflecting face in the polygon mirror 160 so that it may not be required to increase a thickness of the polygon mirror in proportion to numbers of the light beams. As a result, the polygon mirror 160 may have a thin thickness.

A scan angle may be in inverse proportion to numbers of the reflecting faces in the polygon mirror 160. Thus, although the scan angle may be decreased in proportion to increasing the numbers of the reflecting faces in the polygon mirror 160, scan numbers of the polygon mirror 160 by one rotation of the polygon mirror 160 may be increased. Therefore, a time for scanning the object may be reduced by increasing the numbers of the reflecting faces in the polygon mirror 160.

The first light beam reflected from the reflecting face of the polygon mirror 160 may exit through a first eccentric exit point EP1 of the scan lens 150. The first eccentric exit point EP1 may be positioned at a left upper portion of the scan lens 150. The first light beam exiting through the first eccentric exit point EP1 may be converted into a planar light beam.

The second light beam reflected from the reflecting face of the polygon mirror 160 may exit through a second eccentric exit point EP2 of the scan lens 150. The second eccentric exit point EP2 may be positioned at a right upper portion of the scan lens 150. The second light beam exiting through the second eccentric exit point EP2 may be converted into a planar light beam. The first eccentric exit point EP1 and the second eccentric exit point EP2 may be substantially coplanar with each other. Thus, the planar first and second light beams may be irradiated to the object on a substantially same horizontal plane.

According to this example embodiment, the first and second eccentric incidence points IP1 and IP2 of the scan lens 150 may be positioned on a plane different from the plane on which the first and second eccentric exit points EP1 and EP2 may be positioned so that the light beams of the multi-beam scanner 100 may scan the object using only one scan lens 150.

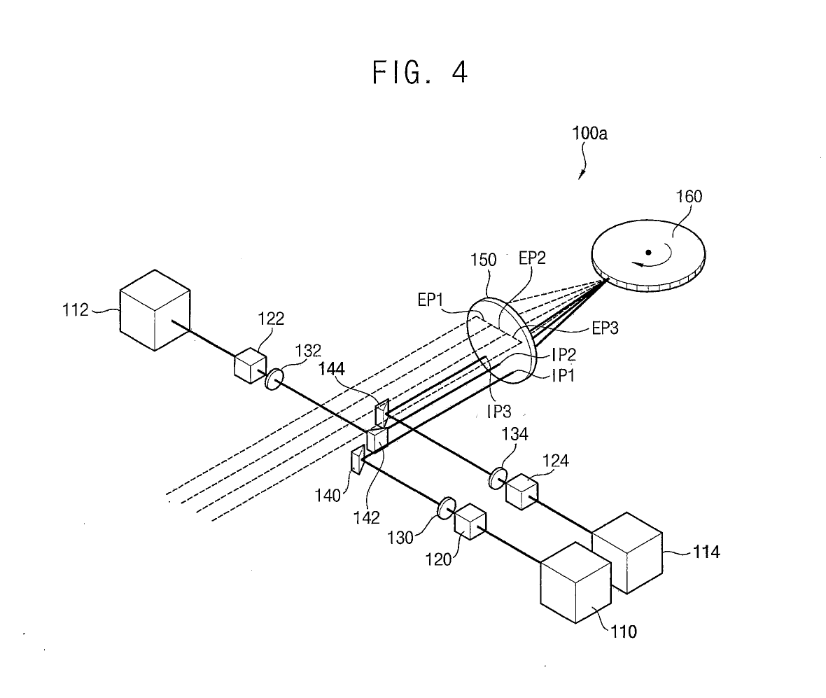

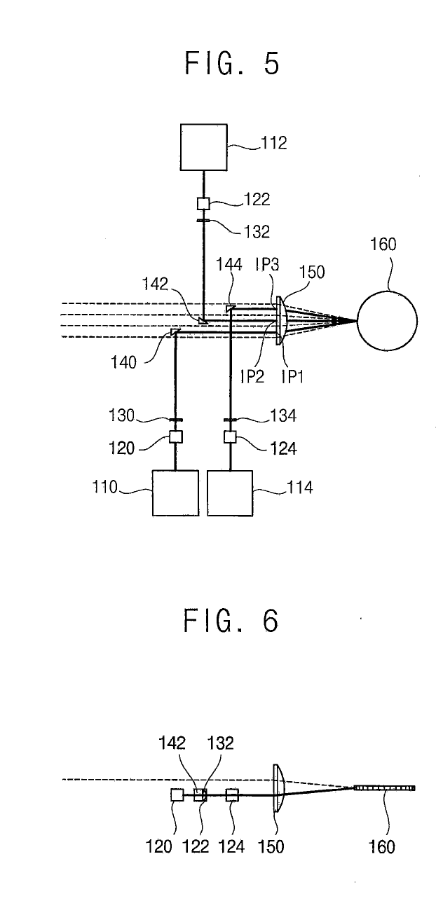

FIG. 4 is a perspective view illustrating a multi-beam scanner in accordance with example embodiments, FIG. 5 is a plan view illustrating the multi-beam scanner in FIG. 4, and FIG. 6 is a front view illustrating the multi-beam scanner in FIG. 4.

A multi-beam scanner 100a of this example embodiment may include elements substantially the same as those of the multi-beam scanner 100 in FIG. 1 except for further including a third light source, a third beam splitter, a third convex lens and a third inclined mirror, Thus, the same reference numerals may refer to the same elements and any further illustrations with respect to the same elements may be omitted herein for brevity.

Referring to FIGS. 4 to 6, the second light source 112 may be arranged adjacent to the scan lens 150 closer than the first light source 110. Thus, a distance between the scan lens 150 and the second light beam source 112 may be shorter than a distance between the scan lens 150 and the first light source 110.

The second inclined mirror 142 may be oriented toward a lower portion of the center point of the scan lens 150. Thus, the second eccentric incidence point IP2 to which the second light beam reflected from the second inclined mirror 142 may be irradiated may be positioned at a central lower portion of the scan lens 150.

A third light source 114 may be arranged at a right portion between the scan lens 150 and the object. The third light source 114 may be positioned under the horizontal center axis of the scan lens 150. The third light source 114 may be substantially coplanar with the first and second light sources 110 and 112. The third light source 114 may emit a third light beam along a third optical path substantially perpendicular to the horizontal center axis. The third optical path may be positioned between the first optical path and the second optical path.

A third beam splitter 124 may be arranged on the third optical path in front of the third light source 114. The third beam splitter may split the third light beam emitted from the third light source 114.

A third convex lens 134 may be arranged on the third optical path in front of the third beam splitter 124. The third convex lens 134 may concentrate the third light beam split by the third beam splitter 124.

A third inclined mirror 144 may be arranged on the third optical path. The third inclined mirror 144 may reflect the third light beam concentrated by the third convex lens 134 at an angle of about 90° toward the scan lens 150. The third light beam reflected from the third inclined mirror 144 may be substantially parallel to the horizontal center axis of the scan lens 150. The third light beam reflected from the third inclined mirror 144 may be irradiated to a third eccentric incidence point IP3 of the scan lens 150 offset from the center point of the scan lens 150. The third eccentric incidence point IP3 may be positioned at a left lower portion of the scan lens 150.

The first light beam passing through the first eccentric incidence point IP1 of the scan lens 150, the second light beam passing through the second eccentric incidence point IP2 of the scan lens 150 and the third light beam passing through the third eccentric incidence point IP3 may be concentrated on any one of the reflecting faces of the polygon mirror 160.

The first light beam reflected from the reflecting face of the polygon mirror 160 may exit through a first eccentric exit point EP1 of the scan lens 150. The first eccentric exit point EP1 may be positioned at a left upper portion of the scan lens 150. The first light beam exiting through the first eccentric exit point EP1 may be converted into a planar light beam.

The second light beam reflected from the reflecting face of the polygon mirror 160 may exit through a second eccentric exit point EP2 of the scan lens 150. The second eccentric exit point EP2 may be positioned at a central upper portion of the scan lens 150. The second light beam exiting through the second eccentric exit point EP2 may be converted into a planar light.

The third light beam reflected from the reflecting face of the polygon mirror 160 may exit through a third eccentric exit point EP3 of the scan lens 150. The third eccentric exit point EP3 may be positioned at a right upper portion of the scan lens 150. The third light beam exiting through the third eccentric exit point EP3 may be converted into a planar light beam.

In example embodiments, the object may be scanned using the two or three light beams on the horizontal plane. Alternatively, the numbers of the light beams may be at least four.

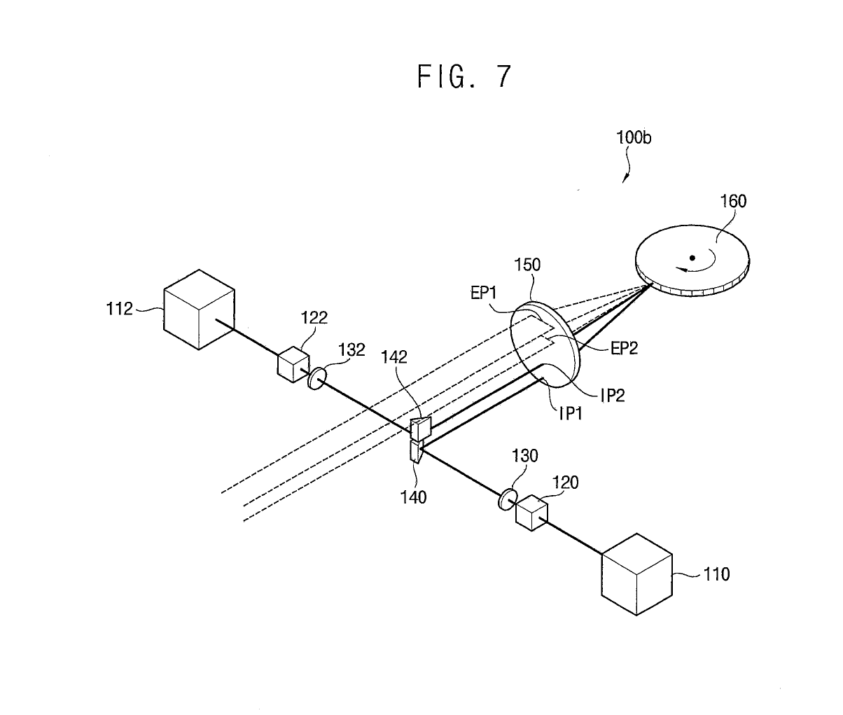

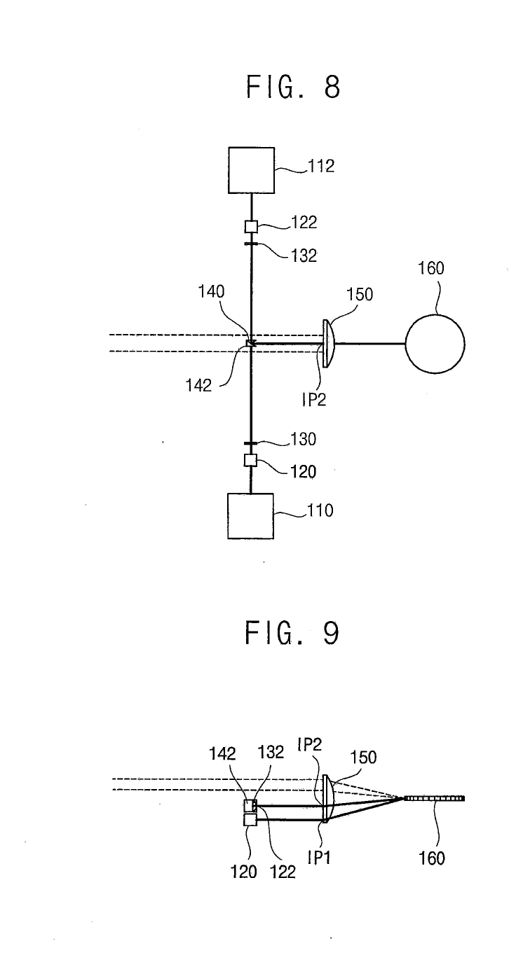

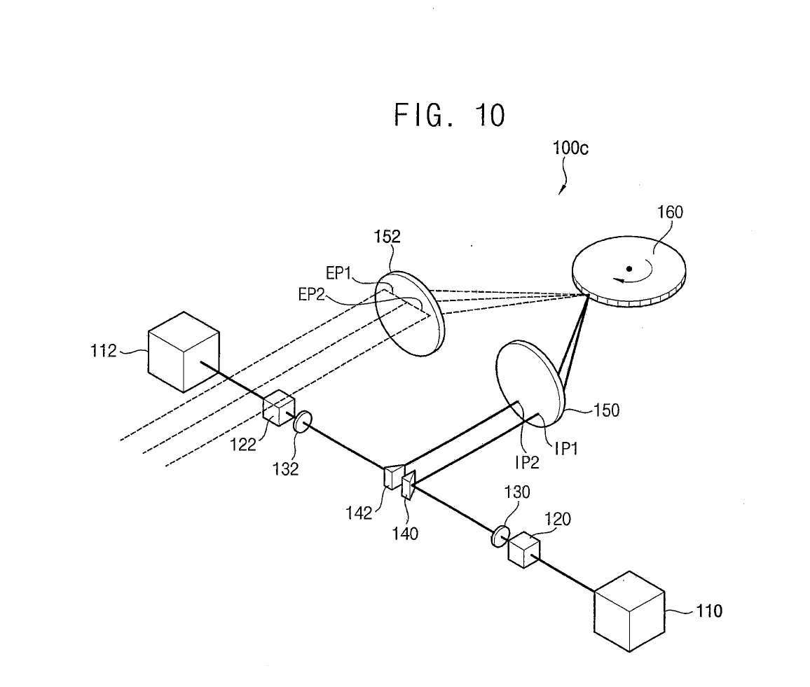

FIG. 7 is a perspective view illustrating a multi-beam scanner in accordance with example embodiments, FIG. 8 is a plan view illustrating the multi-beam scanner in FIG. 7, and FIG. 9 is a front view illustrating the multi-beam scanner in FIG. 7.

A multi-beam scanner 100b of this example embodiment may include elements substantially the same as those of the multi-beam scanner 100 in FIG. 1 except for positions of the first optical path and the second optical path. Thus, the same reference numerals may refer to the same elements and any further illustrations with respect to the same elements may be omitted herein for brevity.

Referring to FIGS. 7 to 9, the second light source 112 may be positioned on a horizontal plane higher than the horizontal plane on which the first light source 110 may be positioned. Thus, the second beam splitter 122, the second convex lens 132 and the second inclined mirror 142 may also be positioned higher than the first beam splitter 120, the first convex lens 130 and the first inclined mirror 140. That is, the second optical path may be positioned higher than the first optical path.

By the above-mentioned arrangements, the second eccentric incidence point IP2 of the scan lens 150 may be higher than the first eccentric incidence point IP1 of the scan lens 150. In contrast, the second eccentric exit point EP2 of the scan lens 150 may be lower than the first eccentric exit point EP1 of the scan lens 150. Therefore, the multi-beam scanner 100b may scan the object using the two light beams parallel to each other in the vertical direction.

In example embodiments, the two light beams may be parallel to each other in the vertical direction. Alternatively, the numbers of the light beams may be at least three.

FIG. 10 is a perspective view illustrating a multi-beam scanner in accordance with example embodiments.

A multi-beam scanner 100c of this example embodiment may include elements substantially the same as those of the multi-beam scanner 100 in FIG. 1 except for further including a second scan lens. Thus, the same reference numerals may refer to the same elements and any further illustrations with respect to the same elements may be omitted herein for brevity.

Referring to FIG. 10, the multi-beam scanner 100c may further include the second scan lens 152. The second scan lens 152 may be arranged at a side portion of the scan lens 150.

The light beams reflected from the polygon mirror 160 may be irradiated to the second scan lens 152. Thus, the second scan lens 152 may have a first eccentric exit point EP1 and a second eccentric exit point EP2. The first and second eccentric exit points EP1 and EP2 of the second scan lens 152 may be substantially the same as the first and second eccentric exit point EP1 and EP2 of the scan lens 150. Thus, any further illustrations with respect to the first and second eccentric exit points EP1 and EP2 may be omitted herein for brevity.

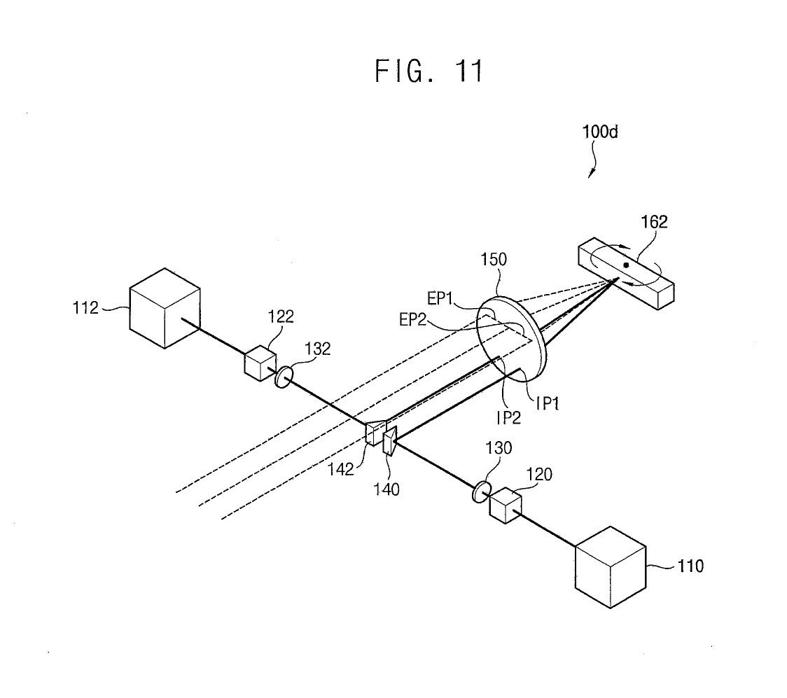

FIG. 11 is a perspective view illustrating a multi-beam scanner in accordance with example embodiments.

A multi-beam scanner 100d of this example embodiment may include elements substantially the same as those of the multi-beam scanner 100 in FIG. 1 except for a reflecting mirror. Thus, the same reference numerals may refer to the same elements and any further illustrations with respect to the same elements may be omitted herein for brevity.

Referring to FIG. 11, the reflecting mirror may include a galvano mirror 162. The galvano mirror 162 may have only one reflecting face. The galvano mirror 162 may be alternately rotated with respect to the vertical axis in a positive direction and a reverse direction to change angles of the reflecting face.

Alternatively, although not depicted in drawings, the reflecting mirror may include a MEMS mirror. The MEMS mirror may be vibrated thousands of times per second to reflect the light beams. The galvano mirror 162 or the MEMS mirror may be used in the multi-beam scanner 100a in FIG. 4, the multi-beam scanner 100b in FIG. 7 or the multi-beam scanner 100c in FIG. 10.

The multi-beam scanners may be used for testing a semiconductor device such as a wafer, a mask, etc., or a laser printer. Further, the multi-beam scanners may be used for other uses as well as the above-mentioned uses.

Confocal Optical System

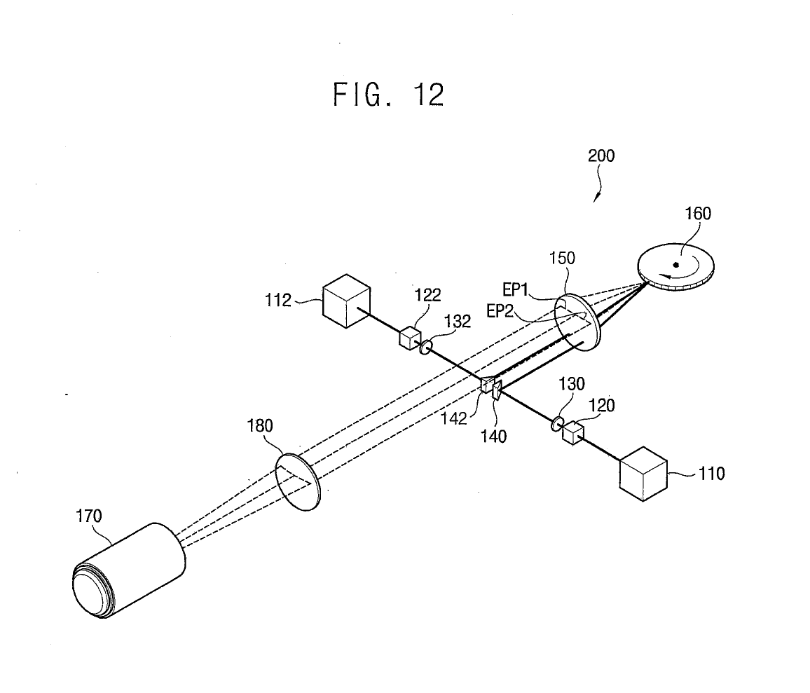

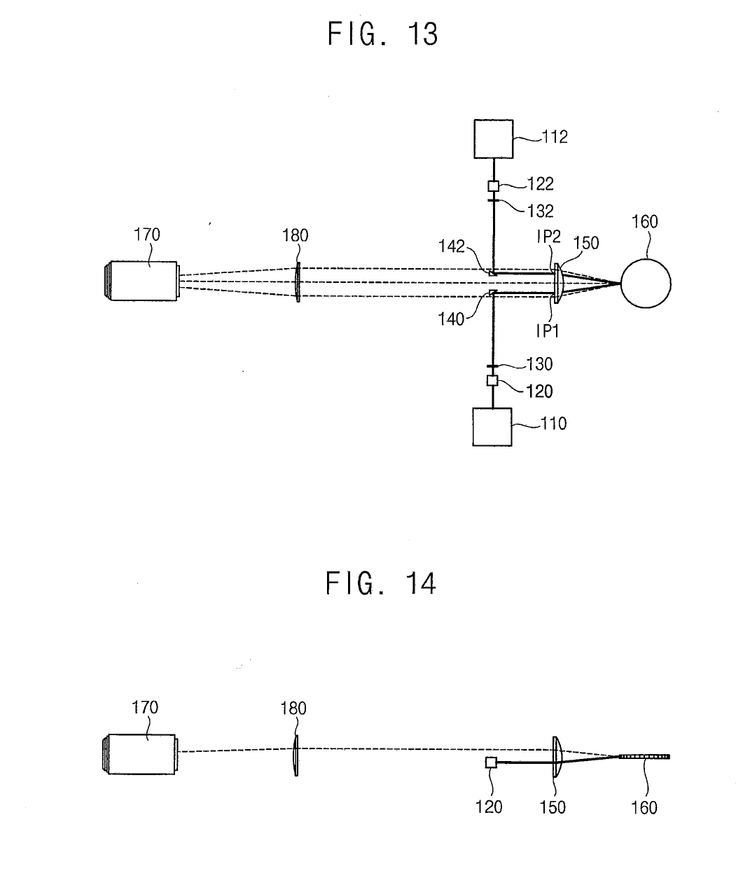

FIG. 12 is a perspective view illustrating a confocal optical system including the multi-beam scanner in FIG. 1, FIG. 13 is a plan view illustrating the confocal optical system in FIG. 12, and FIG. 14 is a front view illustrating the confocal optical system in FIG. 12.

Referring to FIGS. 12 to 14, a confocal optical system 200 of this example embodiment may include a first light source 110, a second light source 112, a first beam splitter 120, a second beam splitter 122, a first convex lens 130, a second convex lens 132, a first inclined mirror 140, a second inclined mirror 142, a scan lens 150, a polygon mirror 160, an objective lens 170, a second objective lens 180, a first detecting unit 190 and a second detecting unit 192.

A multi-beam scanner including the first light source 110, the second light source 112, the first beam splitter 120, the second beam splitter 122, the first convex lens 130, the second convex lens 132, the first inclined mirror 140, the second inclined mirror 142, the scan lens 150 and the polygon mirror 160 may be substantially the same as the multi-beam scanner 100 in FIG. 1. Thus, any further illustrations with respect to the multi-beam scanner may be omitted herein for brevity. Alternatively, the confocal optical system 200 may include the multi-beam scanner 100a in FIG. 4, the multi-beam scanner 100b in FIG. 7, the multi-beam scanner 100c in FIG. 10 or the multi-beam scanner 100d in FIG. 11.

The objective lens 170 may be arranged between the scan lens 150 and the object. The second objective lens 180 may be arranged between the objective lens 170 and the scan lens 150. The second objective lens 180 may scale down the first and second planar light beams passing through the scan lens 150. The first and second light beams passing through the second objective lens 180 may be irradiated to the objective lens 170. The first and second light beams passing through the objective lens 170 may be irradiated to the object to scan the object. Alternatively, when the objective lens 170 may have the function of the second objective lens 180, the confocal optical system 200 may not include the second objective lens 180.

The first and second light beams reflected from the object may be irradiated to the object lens 170. The objective lens 170 may extract light beams focused on the object from the first and second light beams. The extracted light beams may be directed to the polygon mirror 160 through the second objective lens 180 and the scan lens 150.

The polygon mirror 160 may reflect the light beams toward the scan lens 150. The reflected light beams may be irradiated to the first and second detecting units 190 and 192 through the first and second reflecting mirrors 140 and 142, the first and second convex lenses 130 and 132, and the first and second beam splitters 120 and 122.

According to this example embodiment, the confocal optical system may include the single scan lens and the thin polygon mirror regardless of the numbers of the light beams so that the confocal optical system may have a simple structure. The confocal optical system may be used for a confocal microscope.

According to example embodiments, the incidence points of the light beams may be offset from the center point of the scan lens so that the object may be scanned by the light beams using only one scan lens. Further, the light beams passing through the scan lens may be irradiated to the single point of the reflecting mirror so that the reflecting mirror may have a thin thickness. As a result, the multi-beam scanner and the confocal optical system may have a simple structure.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A multi-beam scanner comprising:
a scan lens having at least two eccentric incidence points to which at least two light beams are directed, wherein the scan lens is configured to focus the at least two light beams to a location; and
a reflecting mirror positioned at the location and configured to reflect the at least two light beams.

2. The multi-beam scanner of claim 1, wherein the at least two light beams are focused to a point on the reflecting mirror.

3. The multi-beam scanner of claim 1, wherein the eccentric incidence points are positioned on a horizontal plane.

4. The multi-beam scanner of claim 1, wherein the reflecting mirror is configured to reflect the at least two light beams to the scan lens.

5. The multi-beam scanner of claim 4, wherein the at least two light beams reflected from the reflecting mirror are converted into planar light beams through eccentric exit points of the scan lens that are different from the eccentric incidence points.

6. The multi-beam scanner of claim 5, wherein the eccentric exit points are positioned on a horizontal plane.

7. The multi-beam scanner of claim 1, wherein the reflecting mirror comprises a polygon mirror having a plurality of reflecting faces and is configured to be rotated about an axis.

8. The multi-beam scanner of claim 1, wherein the reflecting mirror comprises a galvano mirror having one reflecting face, and wherein the reflecting mirror is configured to be alternately rotated about an axis in a first direction and an opposite, second direction.

9. The multi-beam scanner of claim 1, further comprising:
beam splitters configured to split the at least two light beams; and
inclined mirrors configured to reflect the at least two light beams split by the beam splitters to the eccentric incidence points of the scan lens.

10. The multi-beam scanner of claim 9, further comprising convex lenses arranged between the beam splitters and the inclined mirrors to concentrate the at least two light beams split by the beam splitters on the inclined mirrors.

11. A confocal optical system comprising:
a scan lens having at least two eccentric incidence points to which at least two light beams are directed, wherein the scan lens is configured to focus the at least two light beams to a location;
a reflecting mirror positioned at the location and configured to reflect the at least two light beams to the scan lens;
an objective lens positioned between the scan lens and an object; and
a detecting unit configured to detect the at least two light beams reflected from the object.

12. The confocal optical system of claim 11, further comprising a second objective lens positioned between the objective lens and the scan lens to focus the at least two light beams on the objective lens.

13. The confocal optical system of claim 11, wherein the reflecting mirror comprises a polygon mirror having a plurality of reflecting faces, and wherein the reflecting mirror is configured to be rotated about an axis.

14. The confocal optical system of claim 11, further comprising:
beam splitters configured to split the at least two light beams; and
inclined mirrors configured to reflect the at least two light beams split by the beam splitters to the eccentric incidence points of the scan lens.

15. The confocal optical system of claim 14, further comprising convex lenses positioned between the beam splitters and the inclined mirrors to concentrate the at least two light beams split by the beam splitters on the inclined mirrors.

16. A multi-beam scanner comprising:
first and second light sources, wherein the first light source generates a first light beam on a first plane, and wherein the second light source generates a second light beam on a second plane different from the first plane;
a scan lens configured to focus the first and second light beams to a location; and
a reflecting mirror positioned at the location and configured to reflect the first and second light beams back towards the scan lens.

17. The multi-beam scanner of claim 16, wherein the scan lens is configured to redirect the reflected first and second light beams along respective third and fourth planes above the first and second planes.

18. The multi-beam scanner of claim 16, wherein the reflecting mirror comprises a polygon mirror having a plurality of reflecting faces and is configured to be rotated about an axis.

19. The multi-beam scanner of claim 16, wherein the reflecting mirror comprises a galvano mirror having one reflecting face, and wherein the reflecting mirror is configured to be alternately rotated about an axis in a first direction and an opposite, second direction.

20. The multi-beam scanner of claim 16, further comprising:
a first beam splitter configured to split the first light beam;
a first inclined mirror configured to reflect the first light beam split by the first beam splitter towards the scan lens;
a second beam splitter configured to split the second light beam; and
a second inclined mirror configured to reflect the second light beam split by the second beam splitter towards the scan lens.
